(19) United States
(12) Patent Application Publication
(10) Pub. No.: US 2025/0105533 A1
(43) Pub. Date: Mar. 27, 2025

(54) JOINT TERMINAL

(71) Applicant: YAZAKI CORPORATION, Tokyo (JP)

(72) Inventor: Ryuta Fujii, Makinohara-shi (JP)

(21) Appl. No.: 18/822,029

(22) Filed: Aug. 30, 2024

(30) Foreign Application Priority Data
Sep. 25, 2023 (JP) 2023-160218

(51) Int. Cl. H01R 11/28; H01R 11/01

(52) U.S. Cl. CPC H01R 11/28; H01R 11/01

(57) ABSTRACT

A plate-shaped joint terminal is provided in an elongated shape. The joint terminal includes a first mounting portion which is provided on one side in a longitudinal direction and on which a first electric wire is mounted, a first crimping piece provided on the first mounting portion and configured to crimp the first electric wire, a second mounting portion which is provided on the other side in the longitudinal direction and on which a second electric wire is mounted, a second crimping piece provided on the second mounting portion and configured to crimp the second electric wire, and an abutting portion formed by bending an end portion on the other side in the longitudinal direction toward a thickness direction of the second mounting portion such that the abutting portion abuts against a tip end surface of the second electric wire.

### CROSS-REFERENCE TO RELATED APPLICATIONS

This application is based on and claims priority under 35 USC 119 from Japanese Patent Application No. 2023-160218 filed on Sep. 25, 2023, the entire content of which is incorporated herein by reference.

### TECHNICAL FIELD

The present disclosure relates to a joint terminal.

### BACKGROUND ART

A joint terminal described in JP2016-081625A is known as the joint terminal described above. In the joint terminal described in JP2016-081625A, two electric wires are crimped and connected to each other.

The joint terminal described in JP2016-081625A is crimped to a joint terminal in a state where tip end surfaces of the two electric wires face each other. However, in a case where it is desired to crimp the tip end surfaces of the two electric wires toward the same direction, when one electric wire is attached in a state where the other electric wire is attached, there is a problem that it is difficult to adjust a protruding margin of the electric wire with respect to a crimping piece.

The present disclosure has been made in view of the above circumstances, and an object of the present disclosure is to provide a joint terminal in which a variation in a protruding margin of an electric wire is prevented.

### SUMMARY OF INVENTION

The present disclosure provides a plate-shaped joint terminal provided in an elongated shape. The joint terminal includes a first mounting portion which is provided on one side in a longitudinal direction and on which a first electric wire is mounted, a first crimping piece provided on the first mounting portion and configured to crimp the first electric wire, a second mounting portion which is provided on the other side in the longitudinal direction and on which a second electric wire is mounted, a second crimping piece provided on the second mounting portion and configured to crimp the second electric wire, and an abutting portion formed by bending an end portion on the other side in the longitudinal direction toward a thickness direction of the second mounting portion such that the abutting portion abuts against a tip end surface of the second electric wire.

The present disclosure is briefly described above. Details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a perspective view of a joint terminal according to a first embodiment of the present disclosure;

FIG. 2 is a side view of the joint terminal shown in FIG. 1;

FIG. 3 is a perspective view of a joint terminal according to a second embodiment of the present disclosure;

FIG. 4 is a side view of the joint terminal shown in FIG. 3; and

FIG. 5 is a partial enlarged view of FIG. 4.

### DESCRIPTION OF EMBODIMENTS

Specific embodiments of the present disclosure will be described below with reference to the drawings.

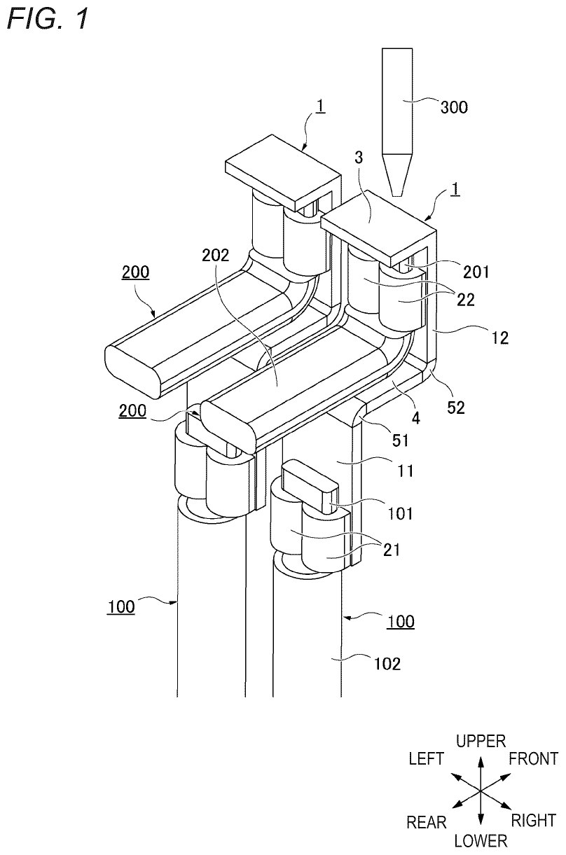

Hereinafter, for convenience of description, as shown in FIGS. 1 to 5, “front”, “rear”, “left”, “right”, “upper”, and “lower” are defined. A “front-rear direction”, a “left-right direction”, and an “upper-lower direction” are orthogonal to one another.

### First Embodiment

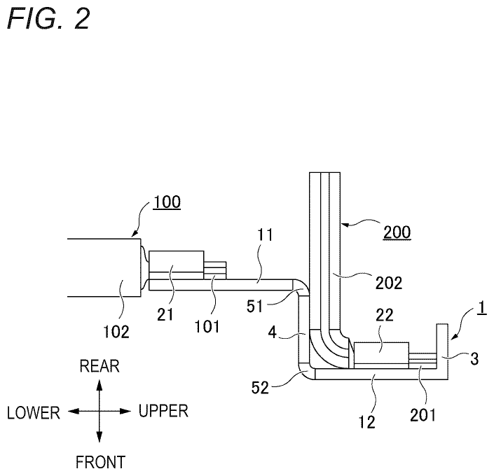

FIGS. 1 and 2 show a joint terminal 1 according to a first embodiment. The joint terminal 1 according to the present embodiment is, for example, a terminal for connecting a coated electric wire 100 (=first electric wire) and a braided wire 200 (=second electric wire) arranged in a vehicle or the like. The coated electric wire 100 includes a core wire 101 and a coating portion 102 that coats the core wire 101. The braided wire 200 includes a core wire 201, an inner insulator (not shown) that coats the core wire 201, a braid (not shown) that coats the inner insulator, and an outer insulator 202 that coats the braid.

The joint terminal 1 is provided by punching and pressing a conductive metal plate. The joint terminal 1 includes two mounting portions 11 and 12, two crimping pieces 21 and 22, an abutting portion 3, an intermediate portion 4, and two bending portions 51 and 52, and is formed into an elongated shape in the upper-lower direction.

The mounting portion 11 (=first mounting portion) is provided on a lower side (=one side in a longitudinal direction), and the coated electric wire 100 is mounted thereon. The mounting portion 11 is disposed perpendicular to the front-rear direction. The crimping piece 21 (=first crimping piece) stands rearward from both sides of the mounting portion 11 in the left-right direction, and crimps the coated electric wire 100. In the present embodiment, the crimping piece 21 is provided at a lower end of the mounting portion 11. At an end of the coated electric wire 100, the coating portion 102 is removed to expose the core wire 101. The coated core wire 101 is mounted on the mounting portion 11 and crimped by the crimping piece 21. The coated electric wire 100 is pulled out downward.

The mounting portion 12 (=second mounting portion) is provided on an upper side (=the other side in the longitudinal direction), and the braided wire 200 is mounted thereon. The mounting portion 12 is disposed perpendicular to the front-rear direction. The crimping piece 22 (=second crimping piece) stands rearward from both sides of the mounting portion 12 in the left-right direction, and crimps the braided wire 200. In the present embodiment, the crimping piece 22 is provided at a substantially center of the mounting portion 12 in the upper-lower direction. At an end of the braided wire 200, the outer insulator 202, the braid (not shown), and the inner insulator (not shown) are removed to expose the core wire 201. The exposed core wire 201 is mounted on the mounting portion 12 and crimped by the crimping piece 22.

The abutting portion 3 is provided by bending an upper end portion of the joint terminal 1 to the rear side in the front-rear direction (=a thickness direction of the mounting portion 12) in an L-shape, and a tip end surface of the core wire 201 of the braided wire 200 abuts against the abutting portion 3 from the lower side. The abutting portion 3 is disposed perpendicular to the upper-lower direction.

The intermediate portion 4 is provided between the mounting portion 11 and the mounting portion 12. The intermediate portion 4 is disposed perpendicular to the upper-lower direction. The bending portion 51 is provided between the intermediate portion 4 and the mounting portion 11, and is formed by bending a rear end portion (an end portion on one side in an extending direction) of the intermediate portion 4 toward the lower side in the upper-lower direction (one side of the intermediate portion 4 in the thickness direction). The bending portion 52 is provided between the intermediate portion 4 and the mounting portion 12, and is formed by bending a front end portion (an end portion on the other side in the extending direction) of the intermediate portion 4 toward the upper side in the upper-lower direction (the other side of the intermediate portion 4 in the thickness direction). The braided wire 200 is bent in an L-shape along the intermediate portion 4, and mounted on the mounting portion 12. That is, the braided wire 200 is pulled out rearward.

A procedure for connecting the coated electric wire 100 and the braided wire 200 using the joint terminal 1 will be described. First, the core wire 101 exposed at the end of the coated electric wire 100 is mounted on the mounting portion 11. At this time, the coated electric wire 100 is mounted in a state where the tip end surface of the core wire 101 is directed upward and the coated electric wire 100 is pulled out from the lower side. Thereafter, a tip end of the crimping piece 21 approaches the core wire 101, and the core wire 101 of the coated electric wire 100 is crimped by the crimping piece 21. The core wire 201 exposed at the end of the braided wire 200 is mounted on the mounting portion 12. At this time, the tip end surface of the core wire 201 of the braided wire 200 is abutted against the abutting portion 3. The braided wire 200 is mounted in a state where the tip end surface of the core wire 201 is directed upward and the braided wire 200 is pulled out from the rear side along the intermediate portion 4. Thereafter, a tip end of the crimping piece 22 approaches the core wire 201, and the core wire 201 of the braided wire 200 is crimped by the crimping piece 22.

According to the embodiment described above, by providing the abutting portion 3 on the joint terminal 1, the tip end surface of the core wire 201 of the braided wire 200 can be abutted against the abutting portion 3. Accordingly, it is possible to prevent a variation in a protruding margin of the braided wire 200 from the crimping piece 22.

As shown in FIG. 1, when a conduction inspection of the braided wire 200 is performed, a conduction inspection probe 300 can be brought into contact with the abutting portion 3. Therefore, since the conduction inspection probe 300 is not directly in contact with the braided wire 200, it is possible to prevent fraying or cutting of the braid.

According to the embodiment described above, the joint terminal 1 is provided with the intermediate portion 4, and the braided wire 200 is bent in an L-shape and mounted on the joint terminal 1. When the tip end of the braided wire 200 is bent in an L-shape, it is more difficult to adjust the protruding margin, but it is possible to prevent the variation in the protruding margin of the braided wire 200 from the crimping piece 22 by the abutting portion 3.

### Second Embodiment

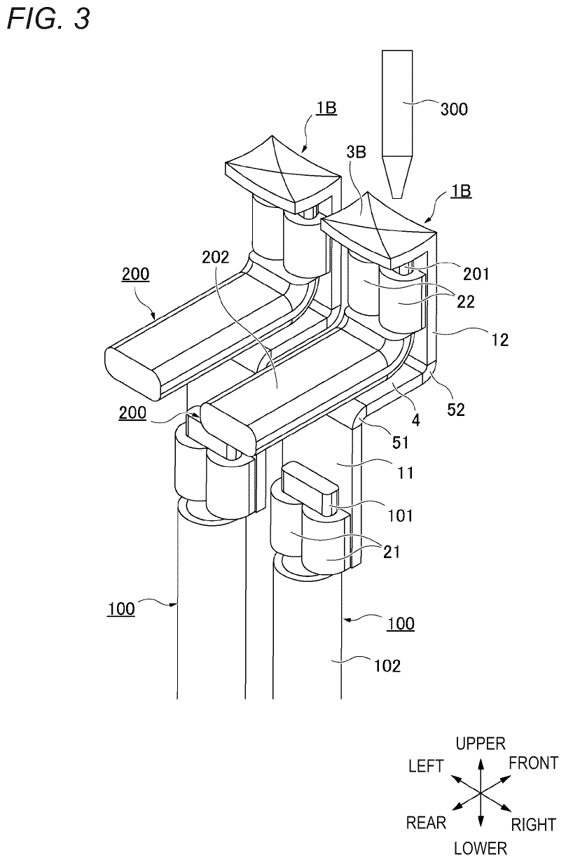

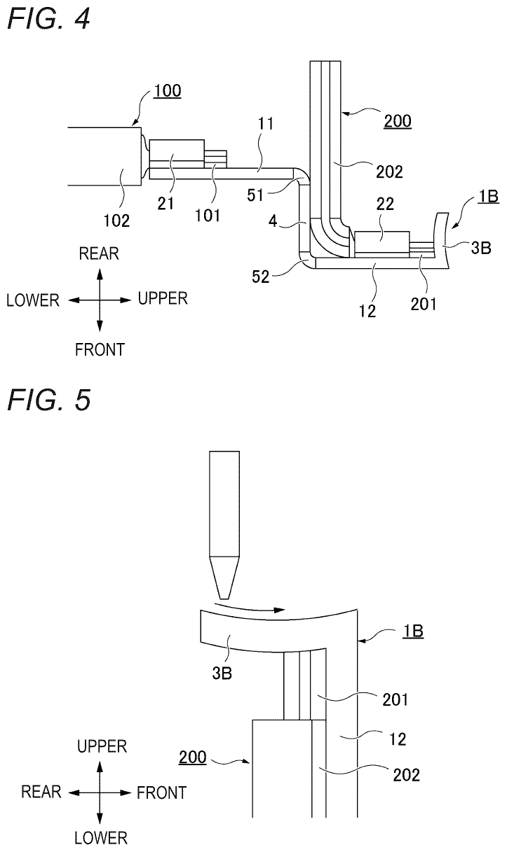

Next, a second embodiment will be described below with reference to FIGS. 3 and 4. In the drawings, portions equivalent to those of the joint terminal 1 shown in FIGS. 1 and 2 already described in the first embodiment described above are denoted by the same reference signs, and the detailed description thereof is omitted.

As shown in the drawings, a joint terminal 1B according to the second embodiment includes the two mounting portions 11 and 12, the two crimping pieces 21 and 22, an abutting portion 3B, the intermediate portion 4, and the two bending portions 51 and 52, and is formed into an elongated shape in the upper-lower direction.

Since the mounting portions 11 and 12, the crimping pieces 21 and 22, the intermediate portion 4, and the bending portions 51 and 52 are equivalent to those in the first embodiment described above, the detailed description thereof will be omitted here. A major difference between the first embodiment and the second embodiment is a shape of the abutting portion 3B. The abutting portion 3 according to the first embodiment is provided in a flat plate shape. The abutting portion 3B according to the second embodiment is provided in a curved shape approaching the tip end surface of the braided wire 200 toward a central portion thereof.

Accordingly, as shown in FIG. 5, when the conduction inspection probe 300 is brought into contact with the abutting portion 3B to perform the continuity inspection, the conduction inspection probe 300 is guided to the central portion of the abutting portion 3B along the curved shape. The conduction inspection can be performed more accurately at a place where the central portion is closest to the braided wire 200.

The present disclosure is not limited to the above embodiment, and modifications, improvements, or the like can be made as appropriate. In addition, materials, shapes, sizes, numbers, arrangement positions, or the like of components in the above embodiment are freely selected and are not limited as long as the present disclosure can be implemented.

According to the first and second embodiments described above, the tip end surface of the braided wire 200 is abutted against the abutting portions 3 and 3B, but the present disclosure is not limited thereto, and the tip end surface of the coated electric wire 100 instead of the braided wire 200 may be abutted against the abutting portions 3 and 3B.

According to the first and second embodiments described above, the bending portions 51 and 52 are provided on both sides of the intermediate portion 4, and the mounting portion 11 and the mounting portion 12 are separated in the front-rear direction, but the present disclosure is not limited thereto. The joint terminals 1 and 1B may be provided such that the mounting portion 11 and the mounting portion 12 are on the same plane without providing the bending portions 51 and 52 on both sides of the intermediate portion 4.

Here, features of the embodiments of the joint terminal according to the present disclosure described above are briefly summarized and listed in the following (i) to (iv).

(i)

A plate-shaped joint terminal (1, 1B) provided in an elongated shape, the joint terminal (1, 1B) includes:
a first mounting portion (11) which is provided on one side (lower side) in a longitudinal direction (upper-lower direction) and on which a first electric wire (100) is mounted;
a first crimping piece (21) provided on the first mounting portion (11) and configured to crimp the first electric wire (100);
a second mounting portion (12) which is provided on the other side (upper side) in the longitudinal direction (upper-lower direction) and on which a second electric wire (200) is mounted;
a second crimping piece (22) provided on the second mounting portion (12) and configured to crimp the second electric wire (200); and
an abutting portion (3, 3B) formed by bending an end portion on the other side (upper side) in the longitudinal direction (upper-lower direction) toward a thickness direction (front-rear direction) of the second mounting portion (12) such that the abutting portion (3, 3B) abuts against a tip end surface of the second electric wire (200).

According to the configuration of (i), by providing the abutting portion (3, 3B) on the joint terminal (1, 1B), the tip end surface of the second electric wire (200) can be abutted against the abutting portion (3, 3B). Accordingly, it is possible to prevent a variation in a protruding margin of the second electric wire (200) from the second crimping piece (22).

(ii)

In the joint terminal (1, 1B) according to (i),
the second electric wire (200) is formed of a braided wire.

According to the configuration of (ii), when a conduction inspection of the braided wire (200) is performed, a conduction inspection probe (300) can be brought into contact with the abutting portion (3, 3B). Therefore, since the conduction inspection probe (300) is not directly in contact with the braided wire (200), it is possible to prevent fraying or cutting of the braid.

(iii)

The joint terminal (1, 1B) according to (i) further includes:
an intermediate portion (4) provided between the first mounting portion (11) and the second mounting portion (12) such that the second electric wire (200) is bent and mounted in an L-shape along the intermediate portion (4);
a first bending portion (51) provided between the intermediate portion (4) and the first mounting portion (11), and formed by bending an end portion of the intermediate portion (4) on one side in an extending direction of the intermediate portion (4) toward one side (lower side) of the intermediate portion (4) in a thickness direction; and
a second bending portion (52) provided between the intermediate portion (4) and the second mounting portion (12), and formed by bending an end portion of the intermediate portion (4) on the other side in the extending direction of the intermediate portion (4) toward the other side (upper side) of the intermediate portion (4) in the thickness direction.

According to the configuration of (iii), the joint terminal (1, 1B) is provided with the intermediate portion (4), and the second electric wire (200) is bent in an L-shape and mounted on the joint terminal (1, 1B). When a tip end of the second electric wire (200) is bent in an L-shape, it is more difficult to adjust the protruding margin, but it is possible to prevent the variation in the protruding margin of the second electric wire (200) from the second crimping piece (22) by the abutting portion (3, 3B).

(iv)

In the joint terminal (1, 1B) according to (i),
the abutting portion (3B) is provided in a curved shape that approaches the tip end surface of the second electric wire (200) toward a central portion of the abutting portion (3B).

According to the configuration of (iv), when the conduction inspection probe (300) is brought into contact with the abutting portion (3B) to perform the continuity inspection, the conduction inspection probe (300) is guided to the central portion of the abutting portion (3B) along the curved shape. The conduction inspection can be performed more accurately at a place where the central portion is closest to the second electric wire (200).

What is claimed is:

1. A plate-shaped joint terminal provided in an elongated shape, the joint terminal comprising:
a first mounting portion which is provided on one side in a longitudinal direction and on which a first electric wire is mounted;
a first crimping piece provided on the first mounting portion and configured to crimp the first electric wire;
a second mounting portion which is provided on the other side in the longitudinal direction and on which a second electric wire is mounted;
a second crimping piece provided on the second mounting portion and configured to crimp the second electric wire; and
an abutting portion formed by bending an end portion on the other side in the longitudinal direction toward a thickness direction of the second mounting portion such that the abutting portion abuts against a tip end surface of the second electric wire.

2. The joint terminal according to claim 1, wherein
the second electric wire is formed of a braided wire.

3. The joint terminal according to claim 1, further comprising:
an intermediate portion provided between the first mounting portion and the second mounting portion such that the second electric wire is bent and mounted in an L-shape along the intermediate portion;
a first bending portion provided between the intermediate portion and the first mounting portion, and formed by bending an end portion of the intermediate portion on one side in an extending direction of the intermediate portion toward one side of the intermediate portion in a thickness direction; and
a second bending portion provided between the intermediate portion and the second mounting portion, and formed by bending an end portion of the intermediate portion on the other side in the extending direction of the intermediate portion toward the other side of the intermediate portion in the thickness direction.

4. The joint terminal according to claim 1, wherein
the abutting portion is provided in a curved shape that approaches the tip end surface of the second electric wire toward a central portion of the abutting portion.
